(19) United States
(12) Patent Application Publication
(10) Pub. No.: US 2017/0314919 A1
(43) Pub. Date: Nov. 2, 2017

(54) LEVELING DEVICE

(71) Applicant: Juan Carlos Guadalajara, Houston, TX (US)

(72) Inventor: Juan Carlos Guadalajara, Houston, TX (US)

(21) Appl. No.: 15/497,143

(22) Filed: Apr. 25, 2017

Related U.S. Application Data
(60) Provisional application No. 62/329,191, filed on Apr. 28, 2016.

(51) Int. Cl. G01C 9/34; A45C 11/36; G01C 9/28

(52) U.S. Cl. CPC G01C 9/34; G01C 9/28; A45C 11/36; G01B 3/04

(57) ABSTRACT

An improved leveling device is a level having variously angled leveling vials along its length and is graduated with indicia using various standards of measurement. Magnetic strips along the top and bottom surface allows the leveling tool to be removably attached to metal, curved, or flat surfaces. A curved or a V-shaped notch along the length of the bottom side allows the level to be centered when placed along the center axis of a pipe, and then held there via the magnetic strips. The leveling vials may be vertically placed in relation to the elongated body, horizontally placed, positioned at 45 degrees, and/or have an adjustable angle. The elongated body has storage compartments for storing various accessories such as pencils or markers, and each compartment as a lid for retaining the accessories. A pencil sharpener is embedded within the elongated main body for handy sharpening of the stored pencils.

### CROSS-REFERENCE TO RELATED APPLICATION

The present application is related to and claims priority from prior provisional application Ser. No. 62/329,191, filed Apr. 28, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of leveling devices and more specifically relates to improved leveling device.

### 2. Description of the Related Art

Correct measurements are immensely important when doing any kind of construction work. Workers need to measure distances from one point to another. Beams and supports that are added must be perfectly level, either horizontally and vertically, or to a specific degree of slope. Measuring tapes are needed to ensure exact lengths and distances, while construction levels are used to determine perfect positioning of added features. Conventional levels are fine when checking the level of a beam with a flat surface, but it is more difficult to be accurate when holding the level against a surface with a curve, such as various sizes of pipes. An extra hand is needed to hold the level, when one hand is used to adjust the material and the other is needed to find a pencil or nail to mark the material. Often, different types of levels must be used all to complete a single task. Extra time is taken and often an extra hand is needed while switching tools. A need exists for a leveling tool that can handle multiple functions to save time and increase convenience.

Various attempts have been made to solve the above-mentioned problems in prior art, however, none of the above inventions and patents taken either singly or in combination is seen to describe the invention as claimed.

Ideally, a leveling device should provide multifunctional operation, and yet, would operate reliably and be manufactured at a modest expense. Thus, a need exists for a reliable improved leveling device to avoid the above-mentioned problems.

### BRIEF SUMMARY OF THE INVENTION

In view of the foregoing disadvantages inherent in the known leveling device art, the present invention provides a novel improved leveling device. The general purpose of the present invention, which will be described subsequently in greater detail, is to provide multifunctional operation.

The improved leveling device preferably comprises an elongated main body having a main axis extending along the elongated length thereof, and three spaced vials each having a liquid therein and each forming a respective bubble having markings thereon adapted to be used to center each respective bubble within each respective vial. The first of the three spaced vials is oriented parallel to the main axis. The second of the three spaced vials is oriented perpendicular to the main axis, and the third of the three spaced vials is oriented at a 45 degree angle to the main axis.

The improved leveling device has two storage compartments located on opposite ends of the elongated main body that are adapted to allow storage of items such as work tools therein. The work tools are chosen from the group of work tools consisting of pencils, erasers, markers, pins, and chalk. The two storage compartments are each approximately ¾ of an inch wide, 7/16 of an inch tall, and 10 inches in depth. The two storage compartments also include removable caps to thereby removably and securely retain items therein and are formed from a rubber material that are removably connected with each respective storage compartment via friction. The removable caps may be pivotally connected to the two storage compartments via respective hinge members.

A V-shaped notch is located on the bottom surface of the main body that is adapted to allow the improved leveling device to be retained on a curved surface. The elongated main body further includes a top surface and a bottom surface that includes magnetic strips embedded therein such that the improved leveling device is adapted to be removably connected to metal surfaces. The elongated main body may be approximately 14 inches in length but can be longer or shorter for various purposes and is graduated using indicia along the main axis that includes inches and centimeters. The indicia are located on top, bottom, front, and back surfaces of the elongated main body.

The elongated main body may also include a pencil sharpener member embedded therein for sharpening pencils which may be stored within the storage compartments for marking materials during use. The elongated main body is formed having an outer shell formed from a material chosen from the group of materials consisting of aluminum, plastic, wood, rubber, and ceramic.

The present invention holds significant improvements and serves as an improved leveling device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, improved leveling device, constructed and operative according to the teachings of the present invention.

FIG. 1 shows a side perspective view illustrating a first embodiment of an improved leveling device according to an embodiment of the present invention.

FIG. 2 is a top view illustrating the improved leveling device according to an embodiment of the present invention of FIG. 1.

FIG. 3 is an end view illustrating the location of the pencil sharpener and V-notch of the improved leveling device according to an embodiment of the present invention of FIG. 1.

FIG. 4 is an opposite end view illustrating the storage compartments of the improved leveling device according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a leveling device and more particularly to a improved leveling device as used to improve the versatility of operation.

Generally speaking, the improved leveling device is a level having variously angled leveling vials along its length and is graduated with indicia using various standards of measurement. Magnetic strips along the top and bottom surface allows the leveling tool to be removably attached to metal surfaces, some of which may be pipe. A curved or a V-shaped notch along the length of the bottom side allows the level to be centered when placed along the center axis of a pipe, and then held there via the magnetic strips. The leveling vials may be vertically placed in relation to the elongated body, horizontally placed, positioned at 45 degrees, or have an adjustable angle. The elongated body has storage compartments for storing various accessories such as pencils or markers, and each compartment as a lid for retaining the accessories. A pencil sharpener is embedded within the elongated main body for handy sharpening of the stored pencils.

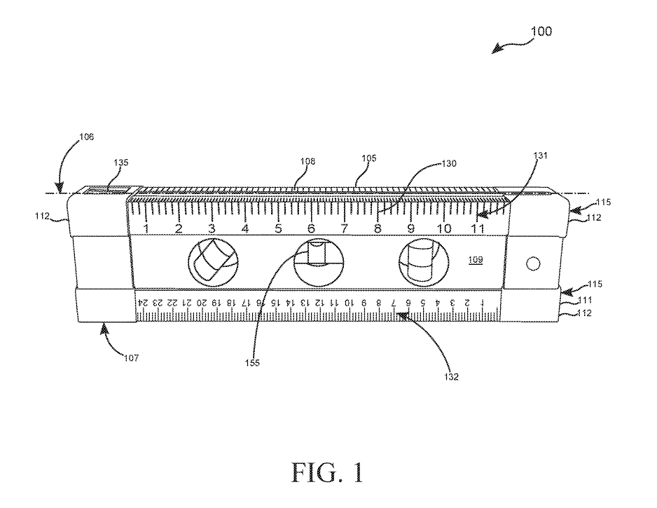

In greater detail now, referring to the drawings by numerals of reference there is shown in FIG. 1, a side perspective view illustrating an improved leveling device 100 according to an embodiment of the present invention.

Improved leveling device 100 preferably comprises elongated main body 105 having main axis 106 extending along the elongated length thereof, and three spaced vials 155 each having a liquid therein and each forming a respective bubble having markings thereon adapted to be used to center each respective bubble within each respective vial 155. The first of the three spaced vials 155 is oriented parallel to main axis 106. The second of the three spaced vials 155 is oriented perpendicular to main axis 106, and the third of the three spaced vials 155 is oriented at a 45 degree angle to main axis 106.

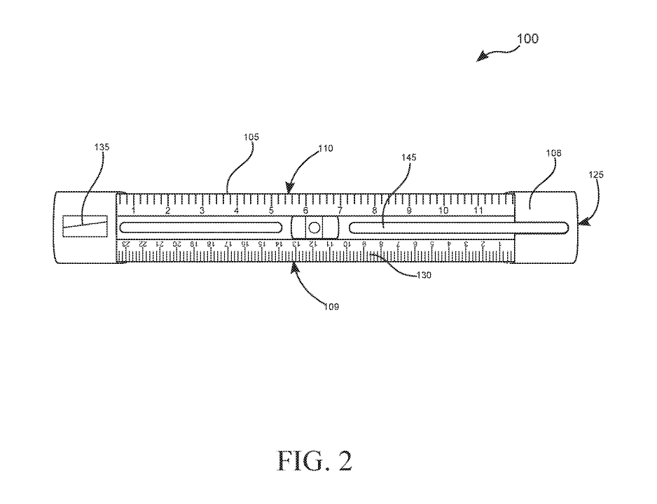

Referring now to FIG. 2, is a side view illustrating the improved leveling device 100 according to an embodiment of the present invention of FIG. 1.

Elongated main body 105 may be approximately 14 inches in length but can be longer or shorter for various purposes and is graduated using indicia 130 along main axis 106 that includes inches and centimeters. Indicia 130 are located on top surface 108, bottom surface 107, front surface 109, and back surface 110 of elongated main body 105.

Elongated main body 105 may also include pencil sharpener member 135 embedded therein for sharpening pencils 140 which may be stored within storage compartment 115 for marking materials during use. Elongated main body 105 is formed having outer shell 111 formed from a material chosen from the group of materials consisting of aluminum, plastic, wood, rubber, and ceramic.

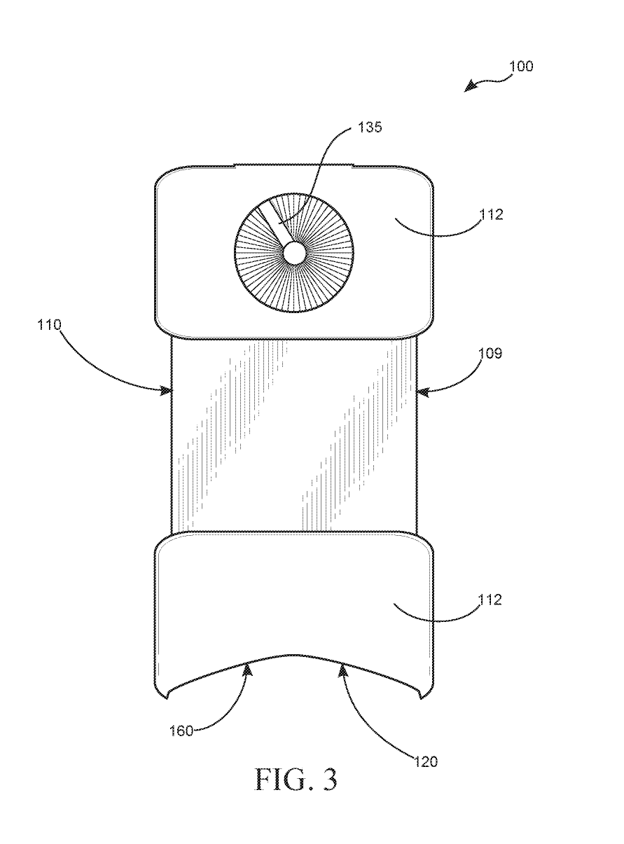

Referring now to FIG. 3, is an end view illustrating the location of pencil sharpener member 135 and V-shaped notch 120 of improved leveling device 100 according to an embodiment of the present invention of FIG. 1.

V-shaped notch 120 is located on bottom surface 107 of elongated main body 105 that is adapted to allow improved leveling device 100 to be retained on a curved surface. Elongated main body 105 further includes top surface 108 and bottom surface 107 that includes magnetic strips 145 embedded therein such that improved leveling device 100 is adapted to be removably connected to metal surfaces.

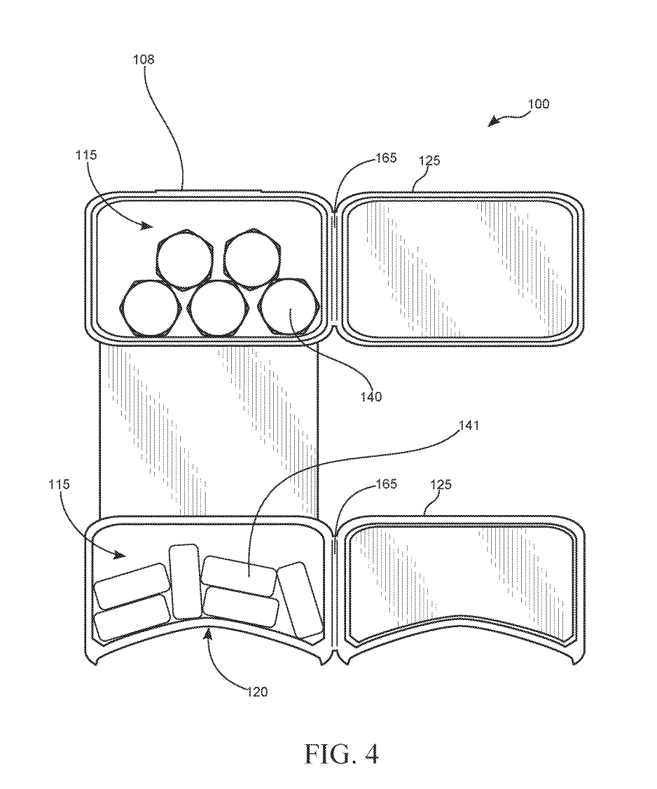

Referring now to FIG. 4, showing an opposite end view illustrating the storage compartments of improved leveling device 100 according to an embodiment of the present invention of FIG. 1.

Improved leveling device 100 has two storage compartments 115 located on opposite ends 112 of elongated main body 105 that are adapted to allow storage of items such as work tools 141 therein. Work tools 141 are chosen from the group of work tools 141 consisting of pencils, erasers, markers, pins, and chalk. The two storage compartment 115 are each approximately ¾ of an inch wide, 7/16 of an inch tall, and 10 inches in depth. The two storage compartments 115 also include removable cap 125 to thereby removably and securely retain items therein and are formed from a rubber material that are removably connected with each respective storage compartment 115 via friction. Removable caps 125 may be pivotally connected to the two storage compartment 115 via respective hinge members 165.

Upon reading this specification, it should be appreciated that, under appropriate circumstances, considering such issues as design preference, user preferences, marketing preferences, cost, structural requirements, available materials, technological advances, etc., other arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An improved leveling device comprising:
an elongated main body including:
a main axis extending along the elongated length thereof;
three spaced vials;
wherein said three spaced vials each have a liquid therein forming a respective bubble;
wherein said three spaced vials each have markings thereon adapted to be used to center each said respective bubble within each respective vial;
wherein a first of said three spaced vials is oriented parallel to said main axis;
wherein a second of said three spaced vials is oriented perpendicular to said main axis;
wherein a third of said three spaced vials is oriented at a 45 degree angle to said main axis;
two storage compartments;
wherein said two storage compartments are located on opposite ends of said elongated main body and are adapted to allow storage of items therein; and
a V-shaped notch;
wherein said V-shaped notch is located on a bottom surface of said main body and is adapted to allow said improved leveling device to be retained on a curved surface.

2. The improved leveling device of claim 1, wherein said two storage compartments include removable caps to thereby removably and securely retain said items therein.

3. The improved leveling device of claim 2, wherein said removable caps are formed from a rubber material and are removably connected with each respective storage compartment via friction.

4. The improved leveling device of claim 1, wherein said elongated main body is approximately 14 inches in length.

5. The improved leveling device of claim 1, wherein said elongated main body is graduated using indicia along said main axis; and wherein said indicia includes inches and centimeters.

6. The improved leveling device of claim 1, wherein said elongated main body further includes a pencil sharpener member embedded therein for sharpening pencils while in use.

7. The improved leveling device of claim 1, wherein said elongated main body further includes a top surface; and wherein said bottom surface and said top surface include magnetic strips embedded therein, such that said improved leveling device is adapted to be removably connected to metal surfaces.

8. The improved leveling device of claim 1, wherein said two storage compartments are each ¾ of an inch wide, 7/16 of an inch tall, and 10 inches in depth.

9. The improved leveling device of claim 1, wherein said elongated main body is formed having an outer shell formed from a material chosen from a group of materials consisting of aluminum, plastic, wood, rubber, and ceramic.

10. The improved leveling device of claim 1, wherein said two storage compartments includes work tools therein.

11. The improved leveling device of claim 10, wherein said work tools are chosen from a group of work tools consisting of pencils, erasers, markers, pins, and chalk.

12. The improved leveling device of claim 5, wherein said indicia is located on top, bottom, front, and back surfaces of said elongated main body.

13. The improved leveling device of claim 1, wherein said elongated main body further includes a curved surface along said elongated length of said bottom surface and is adapted to allow said improved leveling device to be retained upon a length of a curved pipe.

14. The improved leveling device of claim 2, wherein said removable caps are pivotally connected to said two storage compartments vis respective hinge members.
